(19) United States
(12) Patent Application Publication
(10) Pub. No.: US 2006/0112051 A1
(43) Pub. Date: May 25, 2006

(54) Methods and systems for delivering community knowledge

(76) Inventors: Anne Hicks Jeanblanc, Elizabeth, IL (US); James Michael Coffey, Dunlap, IL (US); Benjamin Eugene Newman, Kewanee, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/261,575

(22) Filed: Oct. 31, 2005

Related U.S. Application Data
(63) Continuation-in-part of application No. 09/995,822, filed on Nov. 29, 2001.

(51) Int. Cl. G06N 5/02

(52) U.S. Cl. 706/46

(57) ABSTRACT

Methods and systems for delivering knowledge in a community of practice environment are disclosed. In one embodiment, the system may include a community of practice including members and a knowledge management architecture that manages knowledge used by the community of practice. The knowledge management architecture may also maintain a delivery profile for each member having parameters reflecting a preferred format for receiving updates regarding new knowledge. Further, the knowledge management architecture may be configured to detect new knowledge associated with the community of practice and determine, for a first member, that the new knowledge includes information related to a first profile parameter associated with the first member. Also, the knowledge management architecture may generate a notification for the first member including data associated with a portion of the new knowledge and deliver the notification to the first member. Moreover, the knowledge management architecture may deliver a supplemental version of the new knowledge to the first member in response to a request from the first member to receive the supplemental version of the new knowledge.

### CROSS REFERENCE TO RELATED APPLICATIONS

This application is a continuation-in-part of U.S. patent application Ser. No. 09/995,822, filed Nov. 29, 2001, entitled “Knowledge Management System and Method,” which is incorporated herein by reference in its entirety.

Further, this application is related to U.S. patent application Ser. No. ______, filed ______, entitled METHODS AND SYSTEMS FOR MANAGING KNOWLEDGE DOCUMENTS (Attorney Docket No. 08350.5678), U.S. patent application Ser. No. ______, filed ______, entitled METHODS AND SYSTEMS FOR PROVIDING KNOWLEDGE DOCUMENTS (Attorney Docket No. 08350.5679), and U.S. patent application Ser. No. ______, filed ______, entitled METHODS AND SYSTEMS FOR COLLABORATING COMMUNITIES OF PRACTICE (Attorney Docket No. 08350.5680), each of which is incorporated by reference in its entirety.

### TECHNICAL FIELD

The present invention relates generally to knowledge management, and more particularly, to a method and system for gathering, managing, and sharing knowledge in a community of practice.

### BACKGROUND

Organizations, such as businesses, often rely heavily on knowledge within the organization itself. One example of this reliance is training. Experienced employees are often called upon to train new employees. In addition to training the new employee how to do the job, the experienced employee may also share advice based on lessons the experienced employee learned by doing the same job. Another example is a “resident expert.” Often an employee, through education or experience or both, has become particularly knowledgeable about a topic. Other employees who need advice or information about this topic may contact the “resident expert.” Other examples of important corporate knowledge are internal standards. Internal standards for a procedure or product may be generated and updated by the persons in the organization who are responsible for the procedure or product. The internal standards may be used by the responsible team to ensure that procedures and policies are followed. Further, the internal standards may be used as a guide to quickly train new members of the team. Finally, internal standards may be used by other divisions of the organization as a basis for forming their own standards or for interacting with the responsible team.

Organizational knowledge may be very valuable to an organization. A number of problems exist, however, which may cause the organization to not fully utilize, or even realize the extent of, this organizational knowledge. One problem is that organizational knowledge is often not captured from the knowledgeable employee and documented for use by others. Unless knowledge is documented, it is possible that others within the organization will not be able to determine where particular organizational knowledge resides, and thus the knowledge will be underutilized. Additionally, if a knowledgeable employee leaves the organization without first documenting his knowledge, that knowledge will be lost to the organization. Another problem is that, while an employee may be particularly knowledgeable, until that knowledge has been identified, other persons in the organization (including in other divisions of the organization) may be unaware of the existence of the “resident expert.”

Further, many organizations are becoming increasingly globalized. For example, one company may have corporate headquarters located in one state, research and development facilities located in a second state, manufacturing operations in a number of other states, and retail facilities worldwide. Part of the reason for this globalization is the ease with which communications between these locations may occur. While the technology exists to permit interaction and collaboration among persons at different locations in the organization, current systems do not provide sufficient structure to identify sources of knowledge and enable interaction between persons having knowledge and persons seeking knowledge. Not only does the organizational knowledge need to be globally accessible, but interaction must also be supported.

Finally, in addition to merely capturing the knowledge, it is most effective to provide for interaction and collaboration based on the knowledge. Rather than simply requesting persons to submit any knowledge that they might have, even if directed to a particular topic, it is effective to instead focus the interested persons on a project, goal, or purpose. From the interaction and collaboration that follows based on the project, the knowledge can be captured and documented.

In addition to systems that permit limited interaction, systems also exist that permit some documentation of organizational knowledge. Some of these systems may include mere cataloging of information or mere answering of questions. These systems, however, are limited to a single facet of knowledge, such as “best practices” or internal standards. The systems may also be limited in the persons that may participate. Additionally, these systems are often relatively static and non-interactive. For example, some of these systems may be simply a list of frequently asked questions. At best, some systems refer a user to the person who supplied the knowledge that the user is accessing. The currently available systems do not provide sufficient interaction and/or collaboration with other users to achieve a common purpose based on the knowledge, nor do the current systems provide a dynamic, constantly updating knowledge system. One exemplary existing system is described in U.S. Pat. No. 5,924,072, entitled “Knowledge Management System and Method.” This system provides for the submission of knowledge items by a user, as well as the use of the knowledge items by a second user. The second user may submit feedback about the knowledge item. However, there is no interaction or collaboration between the users; further, the system is designed merely to acquire knowledge.

Additionally, existing systems do not provide an environment that enables knowledge to be efficiently and automatically provided to members based on user specified delivery mechanisms.

The present invention is directed to overcoming one or more of the problems or disadvantages associated with the prior art.

### SUMMARY OF THE INVENTION

Methods and systems for delivering knowledge in a community of practice environment are disclosed. In one embodiment, the system may include a community of practice including members and a knowledge management architecture that manages knowledge used by the community of practice. The knowledge management architecture may also maintain a delivery profile for each member having parameters reflecting a preferred format for receiving updates regarding new knowledge. Further, the knowledge management architecture may be configured to detect new knowledge associated with the community of practice and determine, for a first member, that the new knowledge includes information related to a first profile parameter associated with the first member. Also, the knowledge management architecture may generate a notification for the first member including data associated with a portion of the new knowledge and deliver the notification to the first member. Moreover, the knowledge management architecture may deliver a supplemental version of the new knowledge to the first member in response to a request from the first member to receive the supplemental version of the new knowledge.

In another embodiment, a method for delivering knowledge in a community of practice environment is disclosed. The environment may include a community of practice including members and a knowledge management architecture that manages knowledge used by the community of practice and maintains a member profile for each member having parameters reflecting a preferred format for receiving updates regarding new knowledge. In one embodiment, the method may include detecting new knowledge associated with the community of practice and determining, for a first member, that the new knowledge includes information related to a first profile parameter associated with the first member. Also, the method may include generating a notification for the first member including data associated with a portion of the new knowledge and delivering the notification to the first member. The method may also include delivering a supplemental version of the new knowledge to the first member in response to a request from the first member to receive the supplemental version of the new knowledge.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an exemplary community of practice consistent with one embodiment of the present invention;

FIG. 2 is a block diagram of an exemplary knowledge management architecture consistent with one embodiment of the present invention;

FIG. 3 is a block diagram of an exemplary knowledge management system consistent with one embodiment of the present invention;

FIG. 4 is an exemplary flow chart illustrating a method for creating a community of practice, consistent with one embodiment of the present invention;

FIG. 5 is an exemplary flow chart illustrating a method for managing knowledge, consistent with one embodiment of the present invention;

FIG. 6 is a flowchart of an exemplary knowledge delivery configuration process, consistent with certain disclosed embodiments; and

FIG. 7 is a flowchart of an exemplary knowledge delivery process, consistent with certain disclosed embodiments; and

FIG. 8 shows a block diagram of an exemplary knowledge delivery process, consistent with certain disclosed embodiments.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

A system and method are provided to capture, manage, and share knowledge within an organization. The system and method of the present invention are not limited to knowledge management within an organization, but may be used to facilitate the capture, management, and sharing of knowledge within any organized group of persons working for common goals or purposes. Specifically, a community of practice is formed to facilitate the capturing, managing, and sharing of knowledge. A community of practice is a group of persons (most typically in a single organization) grouped together for a common purpose or to achieve a common goal. For example, a community of practice may be formed to develop a training program for employees in a division, or to create a set of standards for a new product line. A community of practice is not necessarily based on formal divisions within the organization, but may include members from many divisions who are involved in an aspect of the organization or a particular project. Also included in the community of practice is a set of procedures, best practices and standards that the community of practice can use in working towards the purpose or goal. After the goal or purpose is accomplished, the community of practice can continue as an organizational resource.

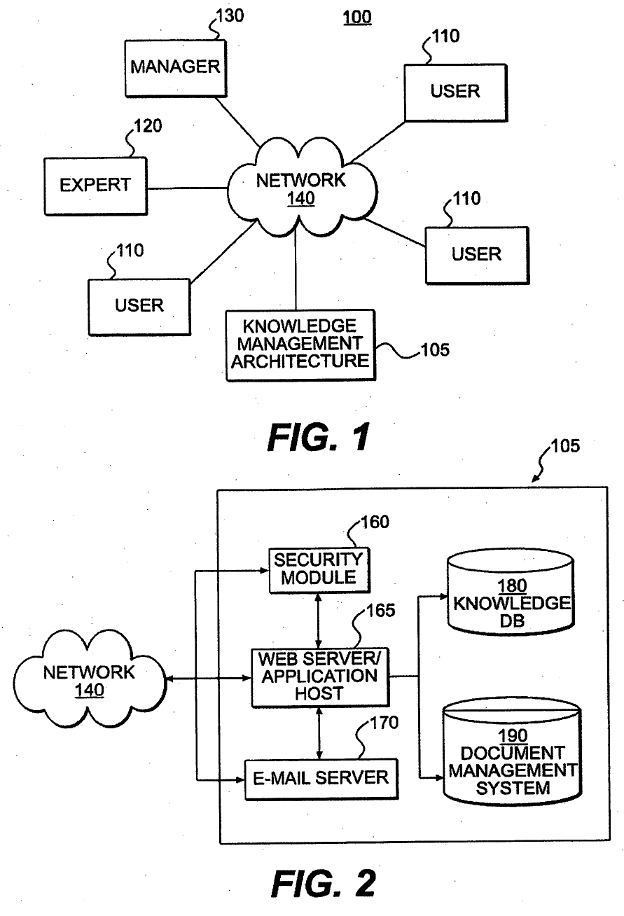

FIG. 1 illustrates an exemplary community of practice 100, consistent with one embodiment of the present invention. As shown in FIG. 1, community of practice 100 includes a knowledge management architecture 105, a plurality of users 110, an expert 120, and a community of practice manager 130, all interconnected by network 140. Knowledge management architecture 105 facilitates interaction among the participants (namely, users 110, expert 120, and manager 130) in community of practice 100. Knowledge management architecture 105 also maintains knowledge entries. Users 110 interact with other users 110, expert 120, and community of practice manager 130 via network 140, for example, by posing questions or responding to the questions of others. Users 110 may also access knowledge entries via knowledge management architecture 105. Further, users 110 may submit their own knowledge to be added to knowledge management architecture 105. Users 110 may interface with community of practice 100 using personal computers, work stations, or other devices connected to network 140.

Expert 120 is similar to user 110, but has been identified within community of practice 100 as having special knowledge. Users 110 may obtain the status of expert 120 through, inter alia, significant participation in a community of practice. In addition to interacting with other entities in community of practice 100 and submitting and accessing knowledge, expert 120 may participate in approving knowledge submitted by users 110. Although only one expert 120 is illustrated in FIG. 1, community of practice 100 may include a plurality of experts.

Community of practice manager 130 functions as the facilitator and moderator for community of practice 100. Community of practice manager 130 may be responsible for review, validation, and dissemination of knowledge in the community of practice. Community of practice 100 may include one or more community of practice managers.

Network 140 may be the Internet, a wireless local area network (LAN), or another type of network. Network 140 is intended in its broadest sense to encompass any communications system.

FIG. 2 is a block diagram illustrating an exemplary knowledge management architecture 105. Knowledge management architecture 105 may include a security module 160, a Web server/application host module 165, an e-mail server 170, a knowledge database 180, and a document management system 190. Security module 160, Web server module 165, and e-mail server 170 interface with network 140. Web server module 165 is connected to e-mail server 170. Web server module 165 is also connected to knowledge database 180 and document management system 190. It is contemplated that a knowledge management system of the present invention may include some or all of the components of FIG. 2.

Security module 160 may determine what type of access each entity in community of practice 100 has with respect to knowledge database 180 and/or the document management system 190. For example, users 110 may access knowledge in knowledge database 180 but may not alter the knowledge. Further, users 110 who wish to add knowledge to knowledge database 180 may require approval of the knowledge before the knowledge is added. Expert 120 and/or community of practice manager 130, on the other hand, may be permitted access to knowledge database 180, as well as the ability to alter knowledge database 180. Further, security module 160 may be used to permit different levels of access to different users, based on, for example, subscription status. For example, anonymous users 110 may be permitted access to only a portion of knowledge database 180, whereas registered users 110 may access the entire knowledge database. While security is important, access is important to achieve interaction and collaboration, and security should be minimized if possible.

Web server/application host module 165 includes an interface for entities to access knowledge database 180, as well as document management system 190. Further, web server module 165 may include additional capabilities, such as collaboration tools to permit entities in community of practice 100 to work together, bulletin boards to permit entities in community of practice 100 to communicate with each other, and/or search engines to provide efficient access to specific knowledge entries in knowledge database 180 or document management system 190. Web server module 165 may also permit entities in community of practice 100 to submit knowledge to be added to knowledge base 180. An exemplary web server application is ColdFusion® by Allaire.

E-mail server 170 provides users 110, expert 120, and community of practice manager 130 with updated information from knowledge management architecture 105. For example, when a new knowledge entry has been approved, e-mail server 170 may forward the knowledge entry to the other entities in the community of practice 100. Alternatively, e-mail server 170 may forward notice of the availability of a new knowledge entry, tool, or standard that may be accessed using Web server module 165.

Knowledge database 180 contains approved knowledge entries, standards, tools, and other information used by entities in community of practice 100. Knowledge management architecture 105 may include one or more knowledge databases 180.

Document management system 190 provides access to documents stored in a number of different formats, such as word processing format, spread sheet format, or presentation format. Document management system 190 permits more rapid capture of knowledge, because documents do not need to be converted before they can be shared with the community of practice.

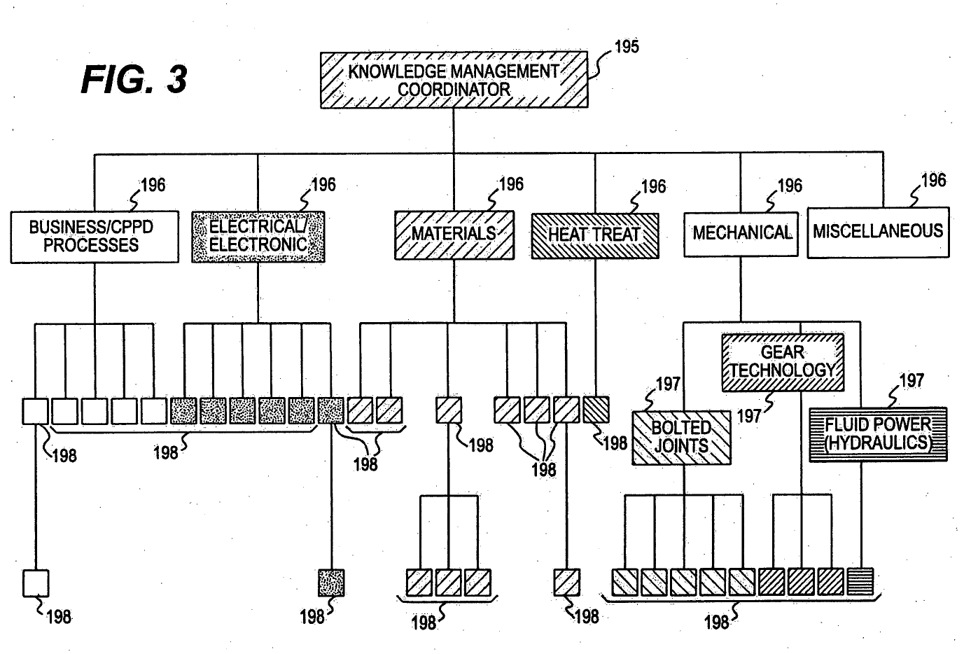

FIG. 3 illustrates an exemplary knowledge management system for an organization, consistent with one embodiment of the present invention. For example, the knowledge management system may include a knowledge management coordinator 195, one or more community groups 196, and one or more communities of practice 198. The one or more community groups may also include one or more sub-community groups 197. Knowledge management coordinator 195 oversees community groups 196 and communities of practice 198. Community groups 196 are logical divisions that may facilitate operation of communities of practice 198 by grouping communities of practice 198 with similar interests or goals. In the exemplary knowledge management system of FIG. 3, the community groups 196 include “Business/CPPD Processes,” “Electrical/Electronic,” “Materials,” “Heat Treat,” “Mechanical,” and “Miscellaneous.” As illustrated in FIG. 3, the “Mechanical” community group may include sub-community groups 197, which include more specific subject areas.

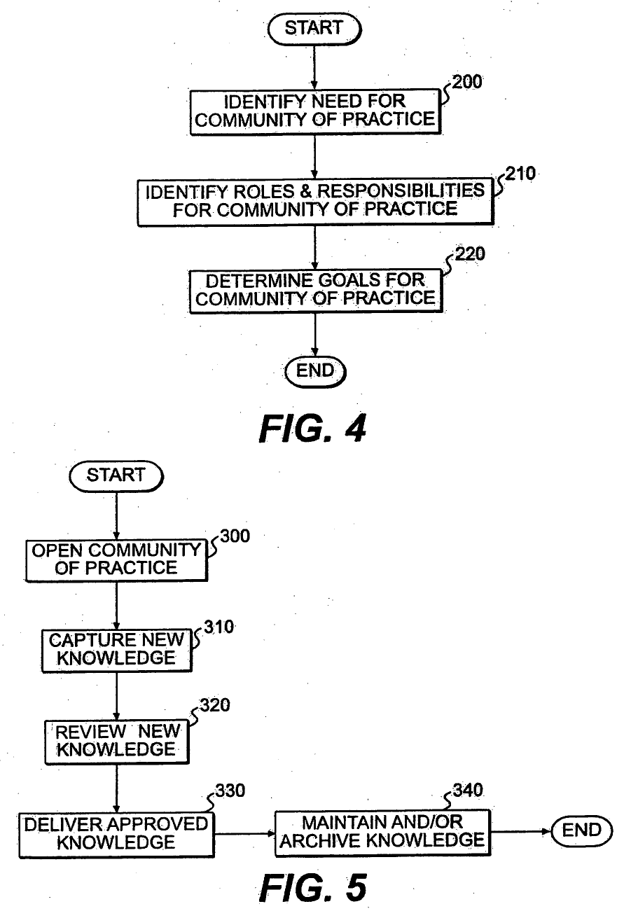

FIG. 4 illustrates an exemplary flow chart of a method for establishing a community of practice. First, a need for a community of practice is identified, for example, by identifying knowledge building activities (step 200). Knowledge building activities may include any activity where problems may be identified, solutions may be generated, or any other body of knowledge may be gathered or created. For example, knowledge building activities may include problem-solving activities, team meetings, firm-wide retreats, or new product designs or launches. A knowledge management coordinator, who may oversee the operation of a number of communities of practice for the organization, may be notified of the new community of practice and may assist with the formation of the new community of practice.

Next, the roles and responsibilities of the community of practice are identified (step 210). One or more community of practice managers may be identified to organize the community of practice and to facilitate and moderate interaction among participants. One or more experts may be associated with the community of practice. In addition, relevant documentation may be identified and collected. For example, existing design guides, training materials, tools, standards, and regulations may be added to the knowledge database (or alternatively, be made available through the document management system). Depending on the roles of various participants in the community of practice, security levels and requirements may also be established. Responsibilities of an expert may include approving knowledge entries submitted by users or periodically answering questions posted via the community of practice. Responsibilities of a manager may include approving knowledge entries submitted by users, organizing interaction between participants in the community of practice, and encouraging participants to work towards the achievement of the goals of the community of practice. It may also be determined to what extent users may participate, and whether different users may have different access to knowledge database. Participants in the community of practice may, if appropriate, receive training in order to enhance their usage of the community of practice.

Goals for the community of practice are then determined (step 220). The goals of the community of practice may include the goals or purposes for which the community of practice was formed. For example, goals may be product-oriented, such as creating a design guide for a new product or developing a software product for testing a new product. Goals may also be information-oriented, such as distributing information from recent symposia or meetings or collecting feedback from organizational locations worldwide to determine required improvements. Further, goals may be career-oriented, such as developing training programs for new employees and providing networking between persons in the organization. Another method for determining goals for the community of practice includes determining what knowledge is missing or what knowledge should be updated. The goal of a community of practice, as encompassed by the present invention, is not the mere cataloging of information within an organization nor the mere answering of questions.

FIG. 5 is an exemplary flowchart illustrating a method for capturing, managing, and sharing knowledge in an established community of practice. Once a community of practice is established, the community of practice is opened (step 300). The community of practice may be advertised within the organization, for example, via company newsletters, e-mails, or other media. Persons wishing to join a community of practice may be asked to enroll or subscribe in the community of practice. There may be different levels of membership, each having a level of security associated. Alternatively, all users may have access to all parts of the knowledge database associated with the community of practice.

The community of practice then may capture new knowledge (step 310). New knowledge may be submitted by users, or may be gathered from interactions (for example, via electronic bulletin board or other collaborative tool) between users via knowledge management architecture 105. Knowledge may include explanations of a situation, commentary on a situation, suggestions for improving a situation, links or references to supporting material, or suggestions of persons who may have additional knowledge. Knowledge may also include information about the person supplying the knowledge. Knowledge may be left in its original format, including word processing, spread sheet, or presentation format. Knowledge that is not in electronic format may be scanned to create an electronic document that may then be attached to electronic mail or messages. By leaving knowledge in the original format, the substance can be reviewed and fine-tuned prior to any conversion.

Next, the captured knowledge is reviewed (step 320). The knowledge may be reviewed to determine if the material is accurate, complete, and/or validated. The knowledge entry may be reviewed by the community of practice manager and/or the expert. Alternatively, the knowledge entry may be reviewed by a review team consisting of a number of persons and resources from within the organization or community of practice.

Once the knowledge entry has been approved, it is delivered (step 330). Delivery of knowledge may include e-mailing the entry to all users who have subscribed to the community of practice. Alternatively, the knowledge entry may be made available for browsing via a Web site associated with the community of practice. Delivered knowledge may also include information about validation and future plans. Further delivered knowledge may include the capability to comment on the knowledge, as well as links to obtain more information or related knowledge. The delivered knowledge may have the capability to be forwarded to non-community of practice members.

Finally, knowledge entries are maintained and/or archived (step 340). Specifically, knowledge entries, such as standards, design guides, training materials, or other procedural information may be validated and updated based on the new knowledge entries. Maintenance of these knowledge entries may include version tracking or other organizational procedures to ensure that the current documents and procedures are being followed. Knowledge entries may also be archived for later use.

The community of practice may also be monitored based on standard metrics, such as usage (such as number of times the knowledge database is accessed), time to market, or other criteria. Once it has been determined that the goals or purposes of the community of practice have been achieved, the community of practice can function as an effective resource for the organization.

### ALTERNATIVE EMBODIMENTS

Methods and systems consistent with the disclosed embodiments enable members to request and receive knowledge to achieve one or more goals of a community of practice. In certain embodiments, members may request information, such as knowledge, from architecture 105. The knowledge may be presented in various formats, such as Web content collected by a Web browser executing on a computer system operated by a member when requesting the knowledge. Additionally, the knowledge may be presented as software files including word processing documents, graphics, executable files, audio files, video files, and any other type of format that information may be configured and processed by a computer system for presentation to a member.

In one embodiment, architecture 105 may be configured to maintain a knowledge delivery profile for each member for controlling how knowledge, such as content, is delivered to each member. In this embodiment, architecture 105 may include a memory device that stores a knowledge delivery profile for each member, such as a database within document management system 190. The knowledge delivery profile may be a data structure including information reflecting a member's preferences for receiving knowledge provided by architecture 105.

In certain embodiments, architecture 105 may be configured to notify members of new knowledge (e.g., entire new knowledge or updated/modified knowledge) that is associated with the members' community of practice. Architecture 105 may, for example, provide the new knowledge to each member in the community of practice. For instance, architecture 105 may include an e-mail server that sends the new knowledge to the members as an attachment to an electronic mail message. Alternatively, or additionally, architecture 105 may provide a notification to each member that new knowledge exists. In response, each member may request and retrieve the new knowledge from architecture 105, via, for example, knowledge database 180.

Methods and systems consistent with the disclosed embodiments also enable new knowledge to be delivered to members more efficiently. For example, in certain embodiments, architecture 105 may generate and manage a knowledge delivery profile for members who register with architecture 105 to automatically receive knowledge in accordance with their respective profiles. For example, a member may register themself, via a computer system, for example, to automatically receive new knowledge from architecture 105 based on one or more delivery profile parameters. The member may customize the one or more delivery profile parameters to control the type of new knowledge to be delivered, when the new knowledge is delivered, and how the new knowledge is delivered to the member by knowledge management architecture 105. In these embodiments, architecture 105 may include software and/or hardware that searches, locates, and delivers new knowledge to registered members. For instance, web server 165 may include a knowledge delivery process that, when executed by a processor, configures knowledge delivery profiles, searches for knowledge based on parameters included in each profile, and delivers knowledge to members based on their respective profile parameters. It should be noted, however, that architecture 105 may include one or more separate components that collectively, or individually, executes the processes of configuring knowledge delivery profiles, searching knowledge, and delivering knowledge. For example, embodiments may employ Real Simple Syndication (RSS) techniques to locate and deliver specific knowledge to a member of a community of practice. Accordingly, the disclosed embodiments are not limited to the examples described herein.

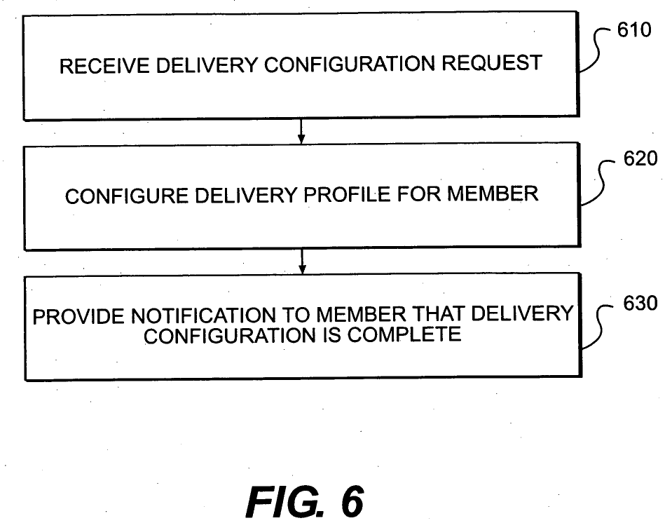

FIG. 6 shows a flowchart of an exemplary knowledge delivery configuration process consistent with certain disclosed embodiments. In one embodiment, architecture 105 may receive a delivery configuration request from a member of a community of practice (Step 610). In one embodiment, the request may identify the member and the community of practice associated with the member. The request may be sent by the member and received by architecture 105 over network 140. For example, a member operating a computer system may send the request via the Internet, a local area network, etc. to architecture 105. The member may also access a Web site managed by Web server 165 that allows the member to request the configuration of a delivery profile via selections and data input areas included on the Web page. Alternatively, the member may send an e-mail to architecture 105 including the request. The disclosed embodiments are not limited to any type of configuration that allows the member to send the request to architecture 105, and the examples described herein are not intended to be limiting.

In response to the request, architecture 105 may configure a delivery profile for the member (Step 620). In certain embodiments, architecture 105 may configure the delivery profile for the member by querying the member for one or more delivery profile parameters that characterize the preferences for receiving new knowledge from architecture 105. For example, the member may access a Web page provided by Web server 165 that allows the member to define one or more delivery profile parameters. Alternatively, architecture 105 may request from the member the delivery profile parameters through other communication mechanisms, such as e-mail, text messaging, etc. A delivery profile parameter represents a type of rule that controls how architecture 105 searches and delivers knowledge to the member.

In certain embodiments, architecture 105 may configure different types of delivery profile parameters for the member. For example, architecture 105 may provide a set of parameters that include one or more terms provided by the member. Further, architecture 105 may provide parameters that each identify the type of knowledge the member prefers to have delivered to them from architecture 105. For example, a member may define a parameter that identifies certain categories of documents, such as technical drawings, publications, business documents, company reports, marketing documents, product information, design documents, specifications, competitor products, competitor names, and any other type of document architecture 105 may offer as a parameter.

Architecture 105 may also enable the member to define a parameter that identifies certain types of knowledge, such as software (e.g., applications, executable code, patches, etc.), HTML pages, word processing documents, etc. Further, architecture 105 may allow the member to define a parameter that identifies certain types of computer languages, speaking languages, authors of a document, names of personnel, part numbers, product numbers, etc. For example, a member may define delivery profile parameters that identify a particular type of product provided by a particular division of a company and/or software products written in a particular software language, or by a particular author, or used by a particular machine, product, etc. Thus, the member profile with this exemplary profile parameter is defined to enable the member to receive information associated with that particular product provided only from the identified company division. Architecture 105 may also allow the member to define when the knowledge identified in their profile is delivered. For instance, the member may define a parameter that directs architecture 105 to deliver discovered knowledge immediately (e.g., when architecture discovers the knowledge via its search processes) every hour, day, week, month, etc. The disclosed embodiments are not limited to the delivery profile parameters identified above. As such, architecture 105 may be configured to offer any type of parameter that the member may define to control how, when, and/or what knowledge is delivered.

Once the delivery profile is configured, architecture 105 may provide notification to the member indicating that the member's delivery profile is configured and that the member is registered to receive new knowledge from architecture 105 in accordance with their profile (Step 630). The notification may be provided via a Web page, e-mail, text message, and any other type of medium and communication protocol that enables architecture 105 to notify the member.

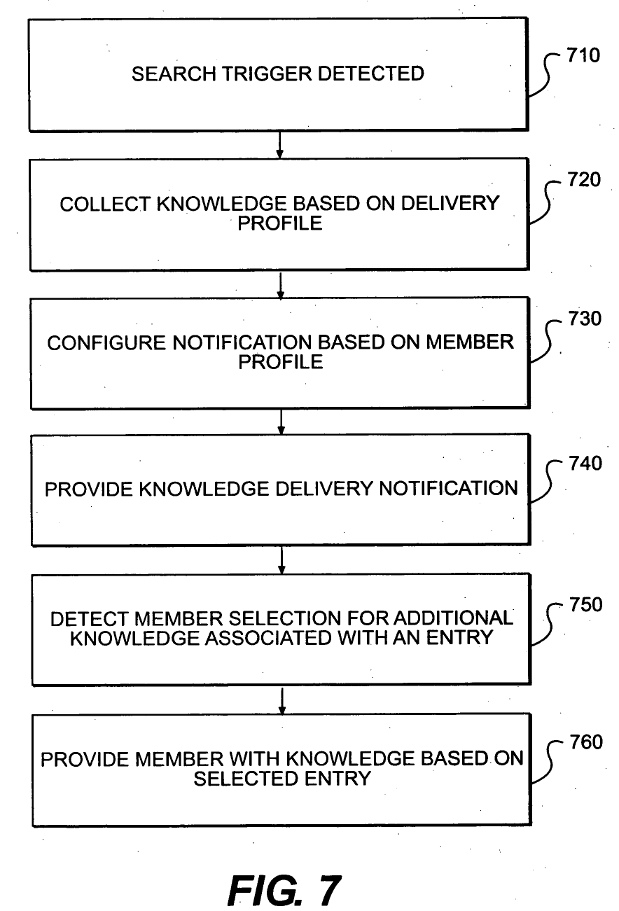

Once registered, a member may receive knowledge automatically from architecture 105 in accordance with their delivery profile. FIG. 7 shows a flowchart of an exemplary knowledge delivery process consistent with certain disclosed embodiments. At some point, architecture 105 may detect a search trigger associated with knowledge managed by architecture 105 (Step 710). A search trigger may be, for example, associated with an event, such as new knowledge being added to database 180, existing knowledge being updated, etc. A search trigger may also be, for example, associated with a software event generated by a process executed by architecture 105. For example, web server 165 may be configured to execute a program that periodically generates a search trigger. In one embodiment, a search trigger period may be defined that is a time frame that enables architecture to search for new knowledge for each of the registered members. That is, architecture 105 may only generate a new search trigger when it receives (via another computer executed process) an indication that all registered member profiles have been processed in accordance with the embodiments disclosed below. Other events, conditions, etc. may be implemented by the disclosed embodiments that generate a search trigger, and the above examples are not intended to be limiting.

In one embodiment, architecture 105 may maintain a copy of any new knowledge in a memory space that is separate from existing knowledge stored in database 180. The memory space may be in database 180 or a different memory device local or remote to architecture 105. Architecture 105 may refresh this memory space each time a search trigger is detected to enable the memory space to maintain only new knowledge received since the last search trigger was detected. The disclosed embodiments may implement any mechanism and technology that enables architecture 105 to identify which knowledge is new and updated in comparison with existing knowledge stored in database 180.

In response to the detected search trigger, architecture 105 may, for each registered member, collect knowledge based on the member's respective delivery profile (Step 720). For example, architecture 105 may analyze a first member's delivery profile parameters to determine the type of knowledge the first member prefers to have delivered. Once the parameters are identified, architecture 105 may search the memory space hosting the new knowledge to determine whether any of the new knowledge includes data related to the first member's delivery profile parameter(s). For example, the first member's profile parameters may include one or more terms indicating the first member prefers to receive any new or updated information associated with a particular component of a product. Thus, architecture 105 may automatically generate a search query to locate any information associated with the particular product that may be included in the new knowledge. If such knowledge is located, architecture 105 may associate the located new knowledge with the first member.

Thus, for each registered member that architecture 105 locates related to new knowledge, architecture 105 may configure a notification based on the respective member's profile (Step 730). In one embodiment, architecture 105 may execute a process that parses information from each related new knowledge in accordance with a member's profile parameter(s). For example, architecture 105 may extract the title, author, abstract, a portion of the body of a document (e.g., first paragraph), etc. from a knowledge document based on a member's delivery profile indicating that this type of information should be included in a notification to the member. Alternatively, the member's delivery profile may include a parameter directing architecture 105 to extract certain portions of a drawing, figures, graphics, audio files, etc. Architecture 105 may add the extracted information into a notification for the member. Alternatively, architecture 105 may execute a program that reviews the related new knowledge for each member, and generates a summary of the knowledge based on the content included in the related new knowledge. Architecture 105 may then generate a notification for each member that includes the extracted portions and/or generated summary of the related new updated knowledge.

Once a notification is configured for a member, architecture 105 may provide the notification to the member based on the member's delivery profile parameters (Step 740). For example, architecture 105 may list in a Web page accessible by the member the new and updated knowledge associated with that member. The list may include the portions and/or summary of the related new and/or updated knowledge generated by architecture 105. In this embodiment, architecture 105 may also send a message to the member indicating that new and/or updated knowledge has been identified and directing the member to the Web page. The member, in response, may use its associated computer system to access the Web page to view the listed information provided by architecture 105. Architecture 105 may configure the Web page such that there is a list including an entry for each new updated knowledge associated with the particular member accessing the Web page. Thus, if three new knowledge documents were identified by architecture 105 for the member, architecture 105 may configure the Web page with three entries, each including their respective summary and/or portions of the knowledge. Further, each entry may include an active link, such as a hyperlink, that directs the member to select in order to receive and view a supplemental version knowledge associated with the entry. A supplemental version may be a full version of the knowledge or a portion of the knowledge that was initially stored in a memory device managed by architecture 105.

Accordingly, in certain embodiments, architecture 105 may detect a member selection for additional content associated with an entry, such as the full version of new knowledge listed in the list of entries (Step 750). For instance, a member viewing the entries via a Web browser application running on the member's computer system, may select a hyperlink included in one of the entries on the Web page provided by architecture 105. In response to the detected member selection, architecture 105 may provide the member with the supplemental version (e.g., full version) of the new knowledge associated with the selected entry (Step 760). In one embodiment, architecture 105 may direct the member to another Web page that includes the supplemental version (e.g., full version) of the new knowledge associated with the selected entry. Additionally, or alternatively, architecture 105 may be configured to retrieve the supplemental version of the new knowledge from the memory space (or database 180) and provide it to the member over network 140 using known data transmission mechanisms (e.g., e-mail delivery, file transfer protocols, etc.). It should be noted, architecture 105 may be configured to provide the full knowledge document to a requesting member using any type of data retrieval and delivery process, and the above examples are not intended to be limiting.

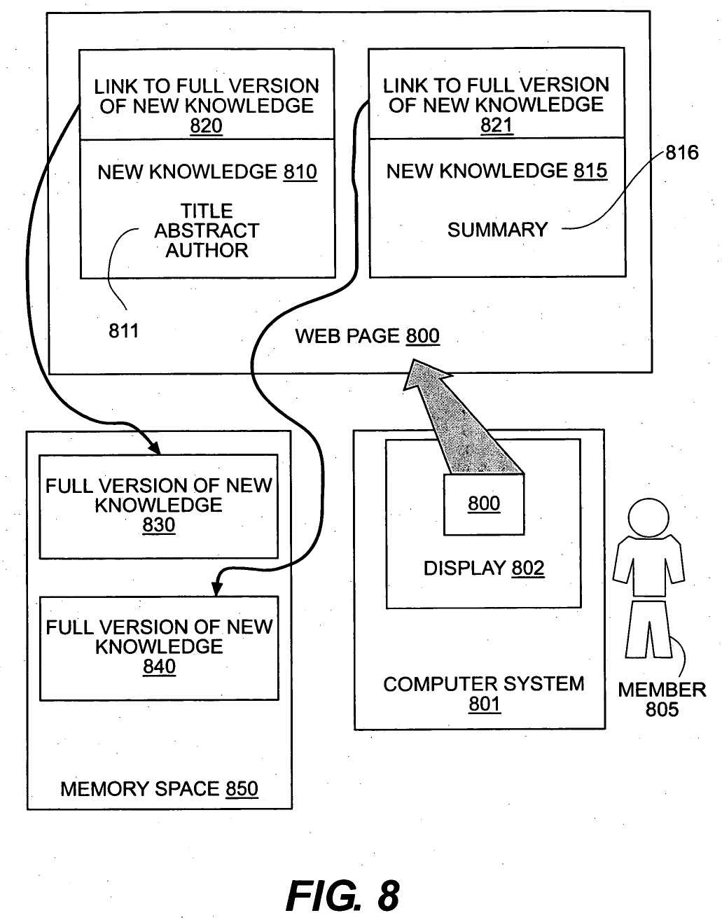

To better illustrate these disclosed embodiments, FIG. 8 shows an block diagram of an exemplary knowledge delivery process for a first member 805 having an associated delivery profile with certain delivery profile parameters. As shown, member 805 operates a computer system 801 including a display 802. In one embodiment, computer system 801 executes a browser application that enables member 805 to access Web sites provided by remote systems, such as Web server 165. In this exemplary illustration, display 802 displays a Web page 800 that is provided by architecture 105 in accordance with certain disclosed embodiments. For example, Web page 800 includes new knowledge entries 810 and 815, each reflecting new knowledge identified by architecture 105 that matches one or more of the delivery profile parameters for member 805. In this example, new knowledge entry 810 includes information 811 reflecting a portion of a full version of new knowledge 830 that is stored in memory space 850. Further, new knowledge entry 815 includes a summary 816 reflecting a summary generated by architecture 105 of a full version of new knowledge 840. Additionally, new knowledge entry 810 includes a link 820 to the full version of new knowledge 830. Similarly, new knowledge entry 815 includes a link 821 to the full version of new knowledge 840. Although FIG. 8 shows full versions of new knowledge 830 and 840, embodiments contemplate this knowledge being supplemental versions of the new knowledge, which may include a full version, or a portion of the new knowledge as it was stored in memory space 850.

Memory space 850 may be stored in database 180 or in another memory device managed by architecture 105. Alternatively, memory space 850 may be associated with a Web page provided by a Web server, which may or may not be associated with Web server 165. In this embodiment, knowledge 830 and 840 may be provided by separate Web pages that may or may not be provided by the same Web server.

In accordance with the example shown in FIG. 8, member 805 may select, using an input device (e.g., mouse) link 820 and/or link 821. In response to this selection, architecture 105 may retrieve the full version of the respective knowledge (e.g., knowledge 830 and 840) for presentation to member 805 via display 802 depending on where this knowledge is stored. For instance, architecture 105 may request from a remote Web server, full knowledge 830. Alternatively, architecture 105 may retrieve full knowledge 830 from database 180.

### INDUSTRIAL APPLICABILITY

Knowledge management using the community of practice system and method of the current invention provide a way to permit interaction and collaboration between persons who have knowledge and persons who are seeking knowledge. The present invention supports internal collaboration among team members in an open environment that encourages participation. Further, the present invention provides for documentation of the knowledge, so that the knowledge is available globally and can be easily identified by those who are seeking it. Other benefits of the present invention include the ability to maintain up-to-date standards and best practices, the ability to quickly train new employees, and the ability to collaborate on an organization-wide level. Up-to-date standards and practices can be kept in a central electronic location, accessible by anyone in the organization, and when updates are required, suggestions can be solicited through the community of practice. New employees can be quickly trained, as all of the tools, standards, best practices, and training material are also available in one location. New employees also have the ability to interact with other employees to answer any questions that might arise. Collaboration on an organization-wide level is possible because e-mails containing new knowledge may be routed immediately to all members of the community of practice, while all tools and other materials are available in one location.

The present invention has clear benefits in helping divisions within an organization share information. For example, one division of a company may have identified a problem, but due to time or budget constraints, was unable to create a software program to analyze the problem. A second division of the company had created a spread sheet tool to analyze the problem; however, the tool was stored locally within the second division and was not accessible to the rest of the company, including the division that had identified the problem. In accordance with an embodiment of the present invention, a user in the second division may have submitted the tool to the community of practice where it was reviewed by experts and approved for use throughout the company. Since putting the tool into use, the tool may have been modified by various users in the community of practice based on their experiences. Thus, the division experiencing the problem would have this valuable corporate resource to draw upon.

As another example of the effective use of the present invention, a user in one division of an organization may post a question to an electronic bulletin board associated with the community of practice. In reply, the user may receive responses from persons throughout the organization. Some of the responses may provide answers or suggestions to the user's question; other responses may direct the user to a person knowledgeable about the topic or may direct the user to documentation existing in the knowledge database.

The community of practice system and method of the present invention has virtually unlimited potential uses. A community of practice may be established whenever there is a business requirement. In certain organizations, this may require notifying and obtaining support from a corporate coordinator. Once necessary approvals are obtained, a community of practice manager, associated experts, and any procedures, specifications, training, and standards that the community of practice would be responsible for are identified. Security levels and requirements would be determined for the community, as well as specific goals for the community to accomplish. Training may be provided as necessary for the community. The community of practice would then be opened in the organizational knowledge management system. Once the new community of practice is advertised, membership and subscriptions of users would be accepted. The progress of the community of practice can be measured with standard metrics. Once the original goals are achieved, the community of practice will continue to be an effective corporate resource.

Methods and systems consistent with the disclosed embodiments may be applied to community of practice environments to allow knowledge to be automatically provided to members of a community of practice. In certain embodiments, each member may configure their own respective delivery profiles that direct a knowledge management system to search and deliver new knowledge according to one or more delivery profile parameters. Thus, a member does not have to manually request to receive updates to any knowledge associated with the member's community of practice. Further, the knowledge management system may save resources by reducing the amount of information sent to each member when new knowledge is detected. For instance, instead of providing supplemental (e.g., full) versions of each new knowledge to each member as the knowledge is added to a community of practice, the knowledge management system may determine, based on each member's profile, which members have an interest in certain types of knowledge, or content included in the new knowledge. Based on this determination, the knowledge management system need only send customized notifications to these certain members, thus reducing the amount of information transmitted on the network(s) used by a community of practice environment. The member may then decide whether they wish to view the supplemental version of the new knowledge identified in their respective notification. The knowledge management system may provide access to the supplemental version of the new knowledge to the first member using any type of data delivery mechanism. For example, the knowledge management system may provide a Web page including a link that, when selected by the member, directs the first member to another Web page including the supplemental version of the new knowledge. The knowledge management system may also provide to the member a data file including the supplemental version of the new knowledge over a network. Further, the knowledge management system may provide the supplemental version of the new knowledge as an attachment to an electronic mail message delivered to the member. Moreover, the knowledge management system may provide a link on a Web page that, when selected by the member, directs the member to a database storing the supplemental version of the new knowledge. For instance, the member may be provided a path file name that identifies where the supplemental version is located on, for example, a shared database disk drive. Alternatively, or additionally, the knowledge management system may extend temporary security rights to the member that enables the member to access a database storing the supplemental version of the new knowledge. It should be noted that any type of delivery mechanism may be implemented and the above examples are not intended to be limiting.

In other embodiments, members may update their delivery profile parameters at any time. Thus, if a member prefers to receive different types of new or updated knowledge, that member need only communicate with the knowledge management system to update their profile. Further, as new members are added to a community of practice, the knowledge management system may be configured to automatically notify the new members of the option of defining their delivery profiles for receiving new or updated knowledge from the management system. Additionally, the disclosed embodiments may allow the knowledge management system to define delivery profile parameters for each member based on software executed at the management system. Thus, in these embodiments, members would receive default types of notifications that are define by the knowledge management system. Alternatively, the disclosed embodiments contemplate allowing one or more members to define delivery profiles for other members in a community of practice. For example, knowledge management architecture 105 may be configured to allow a community of practice manager to define one or more delivery profile parameters for one or more members of the community of practice managed by the manager. Further, the knowledge management system may be configured to form group delivery profiles that are common to a set of members in a community of practice. For example, knowledge management architecture 105 may receive a configuration request from a member to form a group delivery profile that defines one or more delivery profile parameters. One or more members may join (or be assigned to by another member) the group delivery profile, such that each group member receives the same new knowledge notifications in the same format and possibly at the same time periods. Each member of the group may then individually determine whether they wish to view additional content associated with any new knowledge identified in the group notification.

Other aspects and features of the present invention can be obtained from a study of the drawings, the disclosure, and the appended claims.

What is claimed is:

1. A system for delivering knowledge in a community of practice environment, comprising:
a community of practice including members; and
a knowledge management architecture managing knowledge used by the community of practice and maintaining a delivery profile for each member having parameters reflecting a preferred format for receiving updates regarding new knowledge added to the community of practice, the knowledge management architecture configured to:
detect new knowledge associated with the community of practice,
determine, for a first member, that the new knowledge includes information related to a first profile parameter associated with the first member,
generate a notification for the first member including data associated with a portion of the new knowledge,
deliver the notification to the first member, and
deliver a supplemental version of the new knowledge to the first member in response to a request from the first member to receive the supplemental version of the new knowledge.

2. The system of claim 1, wherein the knowledge management architecture detects the new knowledge by searching a memory device storing the new knowledge.

3. The system of claim 2, wherein the new knowledge is submitted to the knowledge management architecture by a member of the community of practice.

4. The system of claim 1, wherein the knowledge management architecture determines, for the first member, that the new knowledge includes information related to a first profile parameter associated with the first member by searching the new knowledge for content that is associated with data included in the first profile parameter.

5. The system of claim 1, wherein the knowledge management architecture is further configured to extract the portion of the new knowledge from the new knowledge based on a second profile parameter associated with the first member.

6. The system of claim 5, wherein the second profile parameter defines a type of information to include in the notification.

7. The system of claim 1, wherein the knowledge management architecture is further configured to:
generate a summary of information included in the supplemental version of the new knowledge; and
include the summary in the notification.

8. The system of claim 1, wherein the knowledge management architecture is further configured to:
receive configuration information from the first member that configures a first delivery profile for the first member including the first parameter.

9. The system of claim 1, wherein the first parameter identifies a type of knowledge that the first member prefers to have delivered by the knowledge management architecture.

10. The system of claim 1, wherein the knowledge management architecture is configured to maintain a first delivery profile for the first member including a set of parameters that include at least one of:
a parameter defining a type of new knowledge the first member prefers to have delivered;
a parameter defining a type of information included in any received new knowledge that the knowledge management architecture is to include in the notification; and
a parameter defining when the knowledge management architecture is to provide the notification to the first member.

11. The system of claim 1, wherein the first parameter identifies a type of knowledge that the first member prefers to have delivered by the knowledge management architecture.

12. The system of claim 11, wherein the first parameter is defined by the first member.

13. The system of claim 1, wherein the knowledge management architecture is configured to deliver the notification by providing a Web page that includes as content the notification and is accessible by the first member.

14. The system of claim 13, wherein the Web page content includes a list identifying the new knowledge detected by the knowledge management architecture.

15. The system of claim 13, wherein the Web page content includes a list of any new knowledge added to the community of practice that includes data that is associated with the first parameter.

16. The system of claim 14, wherein the Web page content includes a link to the supplemental version of the new knowledge.

17. The system of claim 16, wherein the request includes a selection of the link by the first member.

18. The system of claim 17, wherein the knowledge management architecture delivers the supplemental version of the new knowledge by redirecting the first member to another Web page that includes the supplemental version of the new knowledge.

19. The system of claim 1, wherein the knowledge management architecture delivers the supplemental version of the new knowledge by at least one of:
providing a link to first member that, when selected, directs the first member to a Web page including the supplemental version of the new knowledge;
providing a data file including the supplemental version of the new knowledge over a network;
providing the supplemental version of the new knowledge as an attachment to an electronic mail message; and
providing a link to first member that, when selected, directs the first member to a database storing the supplemental version of the new knowledge.

20. A method for delivering knowledge in a community of practice environment including a community of practice including members and a knowledge management architecture that manages knowledge used by the community of practice and maintains a member profile for each member having parameters reflecting a preferred format for receiving updates regarding new knowledge, the method comprising:
detecting new knowledge associated with the community of practice;
determining, for a first member, that the new knowledge includes information related to a first profile parameter associated with the first member;
generating a notification for the first member including data associated with a portion of the new knowledge;
delivering the notification to the first member; and
delivering a supplemental version of the new knowledge to the first member in response to a request from the first member to receive the supplemental version of the new knowledge.

21. The method of claim 20, further including:
searching a memory device storing the new knowledge to detect the new knowledge.

22. The method of claim 21, further including:
receiving the new knowledge by the knowledge management architecture by a member of the community of practice.

23. The method of claim 20, wherein determining includes:
searching the new knowledge for content that is associated with data included in the first profile parameter.

24. The method of claim 20, further including:
extracting the portion of the new knowledge from the new knowledge based on a second profile parameter associated with the first member.

25. The method of claim 24, wherein the second profile parameter defines a type of information to include in the notification.

26. The method of claim 20, further including:
generating a summary of information included in the supplemental version of the new knowledge; and
adding the summary to the notification.

27. The method of claim 20, further including:
receiving configuration information from the first member that configures a first member profile including the first parameter.

28. The method of claim 20, wherein the first parameter identifies a type of knowledge that the first member prefers to have delivered by the knowledge management architecture.

29. The method of claim 20, further including:
maintaining a first member profile for the first member including a set of parameters that include at least one of:
a parameter defining a type of new knowledge the first member prefers to have delivered,
a parameter defining a type of information included in any received new knowledge that the knowledge management architecture is to include in the notification, and
a parameter defining when the knowledge management architecture is to provide the notification to the first member.

30. The method of claim 20, wherein the first parameter identifies a type of knowledge that the first member prefers to have delivered by the knowledge management architecture.

31. The method of claim 30, further including:
defining the first parameter by the first member.

32. The method of claim 20, further including:
providing a Web page that includes as content the notification and is accessible by the first member.

33. The method of claim 32, further including:
providing, in the Web page content, a list identifying the detected new knowledge.

34. The method of claim 32, further including:
providing, in the Web page content, a list of any new knowledge added to the community of practice that includes data that is associated with the first parameter.

35. The method of claim 32, further including:
providing, in the Web page content, a link to the supplemental version of the new knowledge.

36. The method of claim 35, further including:
receiving, as the request, a selection of the link by the first member.

37. The method of claim 36, further including:
redirecting, in response to receiving the selection of the link, the first member to another Web page that includes the supplemental version of the new knowledge.

38. The method of claim 20, wherein delivering the supplemental version of the new knowledge includes at least one of:
providing a link to first member that, when selected, directs the first member to a Web page including the supplemental version of the new knowledge;
providing a data file including the supplemental version of the new knowledge over a network;
providing the supplemental version of the new knowledge as an attachment to an electronic mail message; and
providing a link to first member that, when selected, directs the first member to a database storing the supplemental version of the new knowledge.
